(19) United States
(12) Patent Application Publication
(10) Pub. No.: US 2012/0182537 A1
(43) Pub. Date: Jul. 19, 2012

(54) SPECTRAL PURITY FILTER, LITHOGRAPHIC APPARATUS, AND DEVICE MANUFACTURING METHOD

(75) Inventors: Andrei Mikhailovich Yakunin, Mierlo (NL); Vadim Yevgenyevich Banine, Deurne (NL); Maarten Marinus Johannes Wilhelmus Van Herpen, Heesch (NL); Wouter Anthon Soer, Nijmegen (NL); Martin Jacobus Johan Jak, Eindhoven (NL)

(73) Assignee: ASML Netherlands B.V., Veldhoven (NL)

(21) Appl. No.: 13/497,735

(22) PCT Filed: Aug. 2, 2010
(86) PCT No.: PCT/EP2010/061203

§ 371 Date: Mar. 22, 2012

Related U.S. Application Data
(60) Provisional application No. 61/245,136, filed on Sep. 23, 2009.

(51) Int. Cl. G03B 27/72; G03B 27/32; G02B 5/20

(52) U.S. Cl. 355/71; 359/574; 355/77

(57) ABSTRACT

A spectral purity filter, in particular for use in a lithographic apparatus using EUV radiation for the projection beam, includes a plurality of apertures in a substrate. The apertures are defined by walls having side surfaces that are inclined to the normal to a front surface of the substrate.

### CROSS-REFERENCE TO RELATED APPLICATIONS

This application claims the benefit of U.S. provisional application 61/245,136, which was filed on Sep. 23, 2010 and which is incorporated herein in its entirety by reference.

### FIELD

The present invention relates to spectral purity filters, lithographic apparatus including such spectral purity filters, and methods for manufacturing devices.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

A key factor limiting pattern printing is the wavelength λ of the radiation used. In order to be able to project ever smaller structures onto substrates, it has been proposed to use extreme ultraviolet (EUV) radiation which is electromagnetic radiation having a wavelength within the range of 10-20 nm, for example within the range of 13-14 nm. It has further been proposed that EUV radiation with a wavelength of less than 10 nm could be used, for example within the range of 5-10 nm such as 6.7 nm or 6.8 nm. Such EUV radiation is sometimes termed soft x-ray. Possible sources include, for example, laser-produced plasma sources, discharge plasma sources, or synchrotron radiation from electron storage rings.

EUV sources based on a tin (Sn) plasma not only emit the desired in-band EUV radiation but also out-of-band radiation, most notably in the deep UV (DUV) range (100-400 nm). Moreover, in the case of Laser Produced Plasma (LPP) EUV sources, the infrared (IR) radiation from the laser, usually at 10.6 μm, presents a significant amount of unwanted radiation. Since the optics of the EUV lithographic system generally have substantial reflectivity at these wavelengths, the unwanted radiation propagates into the lithography tool with significant power if no measures are taken.

In a lithographic apparatus, out-of-band radiation should be minimized for several reasons. Firstly, resist is sensitive to out-of-band wavelengths, and thus the image quality may be deteriorated. Secondly, unwanted radiation, especially the 10.6 μm radiation in LPP sources, may lead to unwanted heating of the mask, wafer and optics. In order to bring unwanted radiation within specified limits, spectral purity filters (SPFs) are being developed.

Spectral purity filters can be either reflective or transmissive for EUV radiation. Implementation of a reflective SPF requires modification of an existing mirror or insertion of an additional reflective element. A reflective SPF is disclosed in U.S. Pat. No. 7,050,237. A transmissive SPF is typically placed between the collector and the illuminator and, in principle at least, does not affect the radiation path. This may be an advantage because it may result in flexibility and compatibility with other SPFs.

Grid SPFs form a class of transmissive SPFs that may be used when the unwanted radiation has a much larger wavelength than the EUV radiation, for example in the case of 10.6 μm radiation in LPP sources. Grid SPFs contain apertures with a size of the order of the wavelength to be suppressed. The suppression mechanism may vary among different types of grid SPFs as described in the prior art. Since the wavelength of EUV radiation (13.5 nm) is much smaller than the size of the apertures (typically >3 μm), EUV radiation is transmitted through the apertures without substantial diffraction.

SPFs can be coated by materials that reflect unwanted radiation from the source. Such coatings can include metals that are particularly reflective of IR radiation. However, in use, the SPFs can warm up to high temperatures of around ˜800° C. Such high temperatures in an oxidizing environment can cause the reflective coating to oxidize which leads to a reduction in its reflectivity.

### SUMMARY

It is desirable, for example, to provide a spectral purity filter that improves the transmission of desired radiation.

According to an aspect of the invention, there is provided a spectral purity filter having a plurality of apertures. The filter includes a substrate, including a first surface, and a plurality of walls. The walls have side surfaces that define the plurality of apertures through the substrate. The side surfaces are inclined to a normal to the first surface. In the plane of the first surface, the apertures may have a circular, hexagonal or other cross-section. The apertures may be elongate slits. The spectral purity filter may transmit EUV radiation, for instance radiation of a wavelength of between about 5 nm and about 20 nm. The spectral purity filter may transmit radiation of a second wavelength of about 13.5 nm. Alternatively of additionally, the spectral purity filter may be configured to attenuate at least IR radiation. The spectral purity filter may be configured to attenuate radiation of a wavelength of between about 750 nm and 100 μm or even between 1 μm and 11 μm.

According to an aspect of the invention, there is provided a lithographic apparatus comprising a spectral purity filter as above.

According to an aspect of the invention, there is provided a method of manufacturing a spectral purity filter as above.

According to an aspect of the invention, there is provided a device manufacturing method using a spectral purity filter as above.

According to an aspect of the invention, there is provided a lithographic apparatus that includes a spectral purity filter having a plurality of apertures. The filter includes a substrate, including a first surface, and a plurality of walls, the walls having side surfaces defining the plurality of apertures through the substrate. The side surfaces are inclined to a normal to the first surface. The apparatus also includes an illumination system configured to condition a radiation beam, and a support configured to support a patterning device. The patterning device is configured to impart the radiation beam with a patterned radiation beam. The apparatus also includes a substrate table configured to hold a second substrate; and a projection system configured to project the patterned radiation beam onto a target portion of the second substrate.

According to an aspect of the invention, there is provided a device manufacturing method that includes providing a radiation beam, patterning the radiation beam, projecting the patterned beam of radiation onto a target portion of a substrate, and enhancing the spectral purity of the radiation beam using a spectral purity filter having a plurality of apertures. The filter includes a substrate, including a first surface, and a plurality of walls. The walls having side surfaces defining the plurality of apertures through the substrate. The side surfaces are inclined to a normal to the first surface.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts the layout of a lithographic apparatus according to an embodiment of the present invention;

FIG. 3 depicts a front view of a spectral purity filter according to an embodiment of the present invention;

FIG. 4 depicts a detail of a variation of a spectral purity filter according to an embodiment of the present invention;

FIG. 5 is a cross-sectional view of a spectral purity filter according to an embodiment of the present invention;

FIG. 6 is a cross-sectional view of a spectral purity filter according to an embodiment of the invention; and

FIG. 7 is a cross-section view of a spectral purity filter according to an embodiment of the invention.

### DETAILED DESCRIPTION

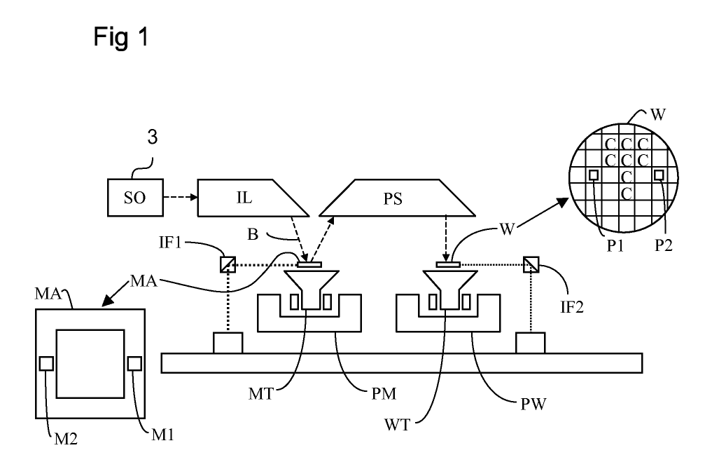

FIG. 1 schematically depicts a lithographic apparatus according to an embodiment of the invention. The apparatus comprises: an illumination system (illuminator) IL configured to condition a radiation beam B (e.g. UV radiation or EUV radiation); a support structure (e.g. a mask table) MT constructed to support a patterning device (e.g. a mask) MA and connected to a first positioner PM configured to accurately position the patterning device in accordance with certain parameters; a substrate table (e.g. a wafer table) WT constructed to hold a substrate (e.g. a resist-coated wafer) W and connected to a second positioner PW configured to accurately position the substrate in accordance with certain parameters; and a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Present proposals for EUV lithography employ reflective patterning devices as shown in FIG. 1. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum.

Any use of the term “projection lens” herein may be considered as synonymous with the more general term “projection system”. For EUV wavelengths, transmissive materials are not readily available. Therefore “lenses” for illumination and projection in an EUV system will generally be of the reflective type, that is to say, curved mirrors.

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system comprising, for example, suitable directing mirrors and/or a beam expander. In other cases the source may be an integral part of the lithographic apparatus, for example when the source is a mercury lamp. The source SO and the illuminator IL, together with the beam delivery system if required, may be referred to as a radiation system.

The illuminator IL may comprise an adjusting device (adjuster) configured to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator and a condenser. The illuminator may be used to condition the radiation beam, to have a desired uniformity and intensity distribution in its cross-section.

The radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF2 (e.g. an interferometric device, linear encoder or capacitive sensor), the substrate table WT can be moved accurately, e.g. so as to position different target portions C in the path of the radiation beam B. Similarly, the first positioner PM and another position sensor IF1 can be used to accurately position the mask MA with respect to the path of the radiation beam B, e.g. after mechanical retrieval from a mask library, or during a scan.

In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

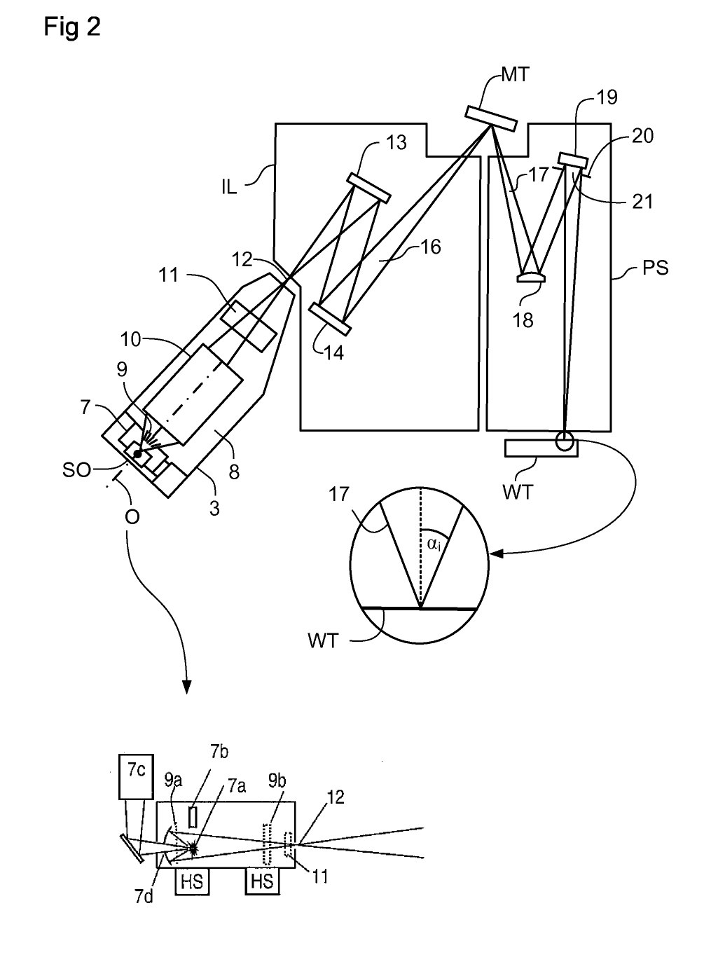

FIG. 2 depicts a schematic side view of an embodiment of an EUV lithographic apparatus. It will be noted that, although the physical arrangement is different to that of the apparatus shown in FIG. 1, the principle of operation is similar. The apparatus includes a source-collector-module or radiation unit 3, an illumination system IL, and a projection system PS. Radiation unit 3 is provided with a radiation source 7, SO which may employ a gas or vapor, such as for example Xe gas or a vapor of Li, Gd or Sn in which a very hot discharge plasma is created so as to emit radiation in the EUV range of the electromagnetic radiation spectrum. The discharge plasma is created by causing a partially ionized plasma of an electrical discharge to collapse onto the optical axis O. Partial pressures of, for example, 10 Pa 0.1 mbar of Xe, Li, Gd, Sn vapor or any other suitable gas or vapor may be desired for efficient generation of the radiation. In an embodiment, a Sn source as EUV source is applied.

The main part of FIG. 2 illustrates radiation source 7 in the form of a discharge-produced plasma (DPP). The alternative detail at lower left in the drawing illustrates an alternative form of source, using a laser-produced plasma (LPP). In the LPP type of source, an ignition region 7a is supplied with plasma fuel, for example droplets of molten Sn, from a fuel delivery system 7b. A laser beam generator 7c and associated optical system deliver a beam of radiation to the ignition region. Generator 7c may be a CO₂ laser having an infrared wavelength, for example 10.6 micrometers or 9.4 micrometers. Alternatively, other suitable lasers may be used, for example having respective wavelengths in the range of 1-11 micrometers. Upon interaction with the laser beam, the fuel droplets are transferred into plasma state which may emit, for example, 6.7 nm radiation, or any other EUV radiation selected from the range of 5-20 nm. EUV is the example of concern here, though a different type of radiation may be generated in other applications. The radiation generated in the plasma is gathered by an elliptical or other suitable collector 7d to generate the source radiation beam having intermediate focus 12.

Returning to the main part of FIG. 2, the radiation emitted by radiation source SO is passed from the DPP source chamber 7 into collector chamber 8 via a contaminant trap 9 in the form of a gas barrier or “foil trap”. This will be described further below. Collector chamber 8 may include a radiation collector 10 which is, for example, a grazing incidence collector comprising a nested array of so-called grazing incidence reflectors. Radiation collectors suitable for this purpose are known from the prior art. The beam of EUV radiation emanating from the collector 10 will have a certain angular spread, perhaps as much as 10 degrees either side of optical axis O. In the LPP source shown at lower left, a normal incidence collector 7d is provided for collecting the radiation from the source.

Radiation passed by collector 10 transmits through a spectral purity filter 11 according to embodiments of the present invention. It should be noted that in contrast to reflective grating spectral purity filters, the transmissive spectral purity filter 11 does not change the direction of the radiation beam. Embodiments of the filter 11 are described below. The radiation is focused in a virtual source point 12 (i.e. an intermediate focus) from an aperture in the collection chamber 8. From chamber 8, the radiation beam 16 is reflected in illumination system IL via normal incidence reflectors 13, 14 onto a reticle or mask positioned on reticle or mask table MT. A patterned beam 17 is formed which is imaged by projection system PS via reflective elements 18, 19 onto wafer W mounted wafer stage or substrate table WT. More elements than shown may generally be present in the illumination system IL and projection system PS. One of the reflective elements 19 has in front of it an NA disc 20 having an aperture 21 therethrough. The size of the aperture 21 determines the angle ∝ᵢ subtended by the patterned radiation beam 17 as it strikes the substrate table WT.

FIG. 2 shows the spectral purity filter 11 positioned closely upstream of the virtual source point 12. In alternative embodiments, not shown, the spectral purity filter 11 may be positioned at the virtual source point 12 or at any point between the collector 10 and the virtual source point 12. The filter can be placed at other locations in the radiation path, for example downstream of the virtual source point 12. Multiple filters can be deployed.

A contaminant trap prevents or at least reduces the incidence of fuel material or by-products impinging on the elements of the optical system and degrading their performance over time. These elements include the collector 10 and the spectral purity filter 11. In the case of the LPP source shown in detail at bottom left of FIG. 2, the contaminant trap includes a first trap arrangement 9a which protects the elliptical collector 7d, and optionally further trap arrangements, such as shown at 9b. As mentioned above, a contaminant trap 9 may be in the form of a gas barrier. A gas barrier includes a channel structure such as, for instance, described in detail in U.S. Pat. Nos. 6,614,505 and 6,359,969, which are incorporated herein by reference. The gas barrier may act as a physical barrier (by fluid counter-flow), by chemical interaction with contaminants and/or by electrostatic or electromagnetic deflection of charged particles. In practice, a combination of these methods are employed to permit transfer of the radiation into the illumination system, while blocking the plasma material to the greatest extent possible. As explained in the mentioned United States patents, hydrogen radicals in particular may be injected by hydrogen sources HS for chemically modifying the Sn or other plasma materials.

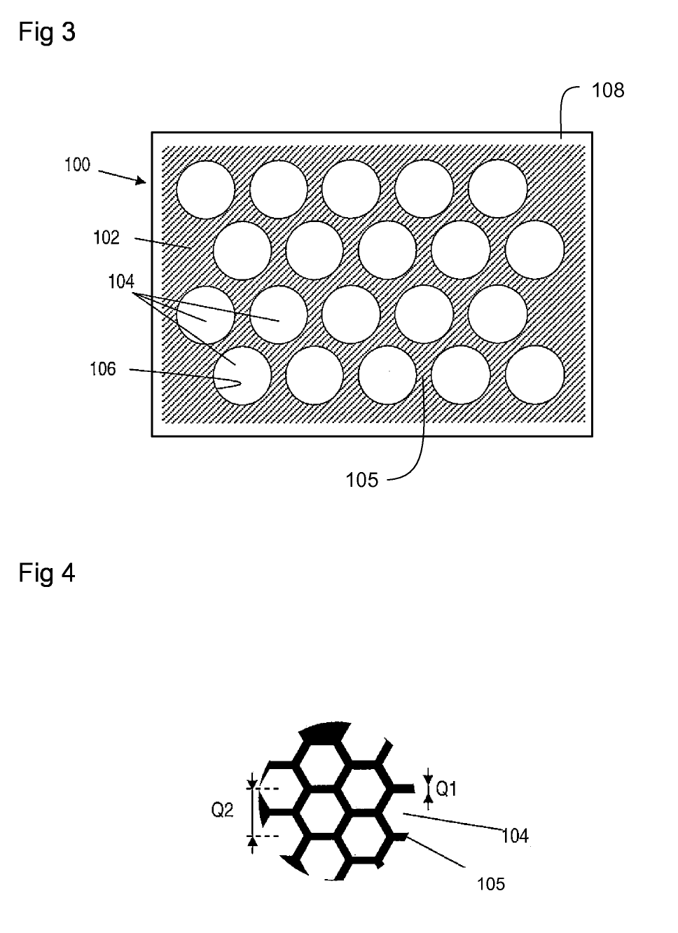

FIG. 3 is a schematic front face view of an embodiment of a spectral purity filter 100, that may for example be applied as an above-mentioned filter 11 of a lithographic apparatus. The filter 100 is configured to transmit extreme ultraviolet (EUV) radiation. In a further embodiment, the filter 100 substantially blocks a second type of radiation generated by a radiation source, for example infrared (IR) radiation, for example infrared radiation of a wavelength larger than about 1 μm, particularly larger than about 10 μm. Particularly, the EUV radiation to be transmitted and the second type of radiation (to be blocked) can emanate from the same radiation source, for example an LPP source SO of a lithographic apparatus.

The spectral purity filter 100 in the embodiments to be described comprises a substantially planar filter part 102 in a first region of the spectral purity filter. The filter part 102 has a plurality of (preferably parallel) apertures 104 to transmit the extreme ultraviolet radiation and to suppress transmission of the second type of radiation. The face on which radiation impinges from the source SO may be referred to as the front face, while the face from which radiation exits to the illumination system IL may be referred to as the rear face. As is mentioned above, for example, the EUV radiation can be transmitted by the spectral purity filter without changing the direction of the radiation. In an embodiment, each aperture 104 has sidewalls 106 defining the apertures 104 and extending completely from the front to the rear face.

The spectral purity filter 100 may include a support frame 108 in a second region of the spectral purity filter that is adjacent the first region. The support frame 108 may be configured to provide structural support for the filter part 102. The support frame 108 may include members for mounting the spectral purity filter 100 to an apparatus in which it is to be used. In a particular arrangement, the support frame 108 may surround the filter part 100.

The aperture size (i.e. the smallest distance across the front face of the aperture) of apparatus 104 is desirably larger than about 100 nm and more desirably larger than about 1 μm in order to allow EUV radiation to pass through the spectral purity filter 100 without substantial diffraction. The aperture size is desirably 10× larger than the wavelength of the radiation to be passed through the aperture and more desirably 100× larger than the wavelength of the radiation to be passed through the aperture. Although the apertures 104 are shown schematically as having a circular cross section (in FIG. 3), other shapes are also possible, and can be preferred. For example, hexagonal apertures, as shown in FIG. 4, may be advantageous from the point of view of mechanical stability.

A wavelength to be suppressed by the filter 100 can be at least 10× the EUV wavelength to be transmitted. Particularly, the filter 100 may be configured to suppress transmission of DUV radiation (having a wavelength in the range of about 100-400 nm), and/or infrared radiation having a wavelength larger than 1 μm (for example in the range of 1-11 microns).

According to an embodiment, EUV radiation is directly transmitted through the apertures 104, preferably utilizing a relatively thin filter 100, in order to keep the aspect ratio of the apertures low enough to allow EUV transmission with a significant angular spread. The thickness of the filter part 102 (i.e. the length of each of the apertures 104) is, for example, smaller than about 20 μm, for example in the range of about 2 μm to about 10 μm. Also, according to an embodiment, each of the apertures 104 may have an aperture size in the range of about 100 nm to about 10 μm. The apertures 104 may, for example, each have an aperture size in the range of about 1 μm to about 5 μm.

The thickness Q1 of the walls 105 between the filter apertures 104 may be smaller than 1 μm, for example in the range of about 0.1 μm to about 0.5 μm, particularly about 0.4 μm. In general, the aspect ratio of the apertures, namely the ratio of the thickness of the filter part 102 to the thickness of the walls between the filter apertures 104, may be in the range of from 20:1 to 4:1. The apertures of the EUV transmissive filter 100 may have a period Q2 (indicated in FIG. 4) of in the range of about 1 μm to about 10 μm, particularly about 1 μm to about 5 μm, for example about 5 μm. Consequently, the apertures may provide an open area of about 50% of a total filter front surface.

The filter 100 may be configured to provide at most 0.01% infrared light (IR) transmission. Also, the filter 100 may be configured to transmit at least 10% of incoming EUV radiation at a normal incidence.

Desirably, the spectral purity filter is coated to maximise reflection of at least one range of unwanted wavelengths, e.g. IR wavelengths. For example, the SPF may be coated with molybdenum (Mo). However, some materials may suffer from oxidation due to high temperatures and an oxidizing environment. This may lead to a reduction in the reflective and emissive properties of the coating. For example, a reflective coating made from molybdenum can suffer from oxidation at temperatures above 600° C. As described in U.S. Provisional Patent Application No. 61/242,987, filed Sep. 16, 2009, which is incorporated herein in its entirety by reference, it is desirable to provide protection against oxidation of the reflective coating. Therefore as described in the above mentioned application, a protective coating of the IR reflective layer, e.g. a thin layer of a metal silicide such as MoSi₂ or WSi₂ can be provided.

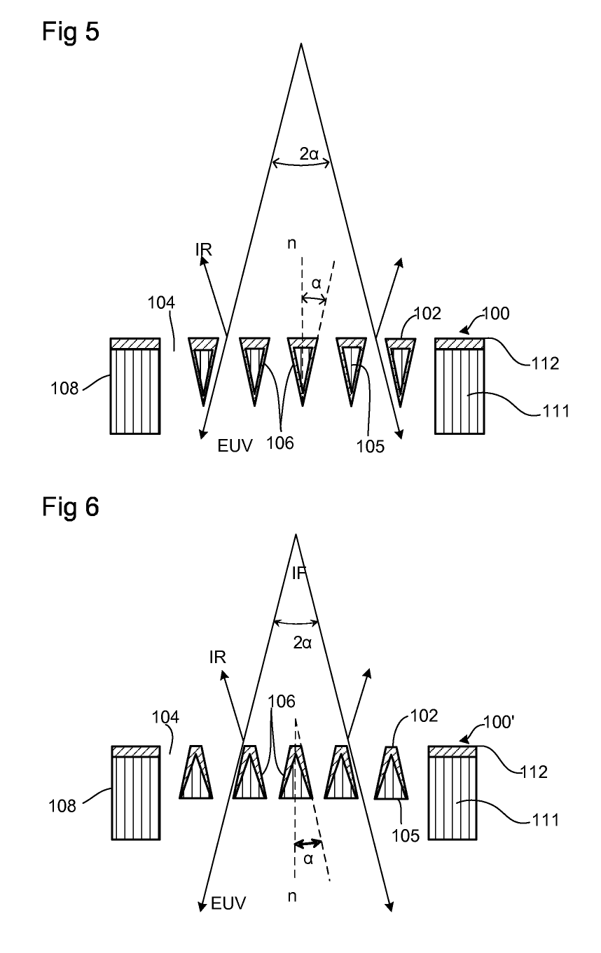

FIG. 5 depicts a cross section of a spectral purity filter according to an embodiment of the present invention. The spectral purity filter 100 comprises apertures 104. The spectral purity filter 100 comprises a substrate or base layer 111. The base layer can be made from Si, a refractory metal such as Mo or W, or silicides such as MoSi₂. A reflective layer 112 is formed on the surfaces of the base layer 111.

As shown in FIG. 5, the side surfaces 106 of walls 105 are inclined relative to the normal to the front face of the filter 100. In particular, the side walls 106 are inclined in such a manner that the width of the apertures 104 increases with increasing distance from the front face of the spectral purity filter 100. In a particular embodiment, the angle a between the side surfaces 106 and the normal n to the front face of the spectral purity filter 100 is half the angle of the spread of the desired radiation beam. The angle a may be less than half the angle of the beam spread of the desired radiation but there is no particular benefit to angle a being greater than half the angle of the beam spread of the desired radiation. In an embodiment, angle α is in the range of from about 1° to about 5°, in particular about 1°, about 2°, about 3°, about 4° or about 5°. As shown in FIG. 5, the cross-section of the walls 105 defining apertures 104 is a triangle, in particular an isosceles triangle. The walls 105 may also be truncated so that their cross-section is a trapezoid (trapezium in British English), in particular an isosceles trapezoid (trapezium).

By inclining the side surfaces 106, it is possible to increase the transmissivity of the spectral purity filter to the desired radiation. The amount of gain that can be achieved depends, inter alia, on the angle of beam spread of the desired radiation and the angle of inclination of the walls. However, an increase in transmissivity of up to 15% can be achieved. In an embodiment the angle of inclination of the side walls 106 varies across the filter. In particular the side walls are perpendicular or nearly perpendicular to the filter face at the center but have an increasing angle of incidence away from the center such that the side walls if continued would intersect at or near the source of the EUV radiation. Variation in the sidewall angles may also occur due to imperfections in the manufacturing process.

FIG. 6 is a cross-section of another spectral purity filter 101′ according to another embodiment of the present invention. In this embodiment, the side walls 106 are inclined so that the width of the apertures 104 decreases away from the front face 102 of the filter 100′. The advantage of this arrangement is that the reflective coating 112 does not reduce the effective size of the apertures 104 and therefore there is no loss of transmission of desired radiation due to the provision of the reflective coating.

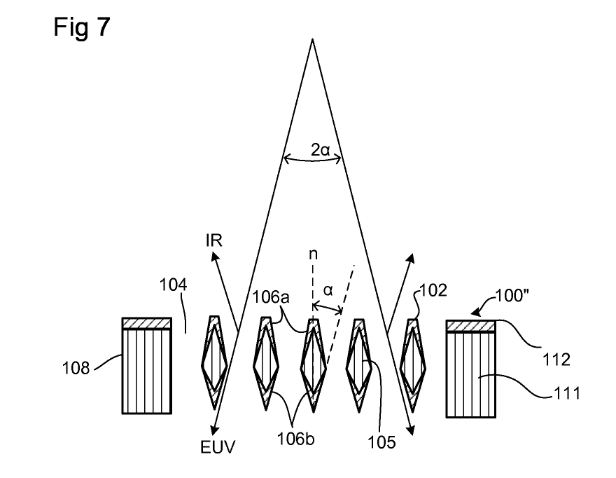

FIG. 7 is a cross-section of another spectral purity filter 101″ according to an embodiment of the invention. In this embodiment, the walls 105 are rhomboid (diamond shaped) or kite-shaped in cross-section so as to obtain the potential benefits of both the embodiments of FIGS. 5 and 6. The absorption of desired EUV radiation due to the depth of the walls 105 and due to the provision of the reflective coating 112 is minimized. In this embodiment, the walls 105 do not need to be symmetrical about a horizontal plane. In other words, the angle of inclination of the side walls 106a above the widest point does not have to equal the angle of inclination of the side walls 106b below the widest point.

In FIG. 7, the reflective coating 112 is shown applied to the lower side walls 106b as well as the upper side walls 106a. The reflective coating may be omitted from the lower sidewalls 106b or a different coating may be applied thereto. The reflective coating 112 is effective on the upper sidewalls 106a to reflect unwanted radiation, e.g. infra-red radiation. In an embodiment with walls 105 of rhomboid cross-section, the angles of inclination may vary across the filter as in the first embodiment.

The spectral purity filter 100 can be manufactured in a number of ways. For example, the apertures in the substrate 111 can be formed by the processes described in U.S. Provisional Patent Application No. U.S. 61/193,769, U.S. Provisional Patent Application No. 61/222,001, U.S. Provisional Patent Application No. 61/222,010, U.S. Provisional Patent Application No. 61/237,614 and U.S. Provisional Patent Application No. 61/237,610, which are incorporated herein their entirety by reference.

It will be understood that the apparatus of FIGS. 1 and 2 incorporating the spectral purity filter may be used in a lithographic manufacturing process. Such lithographic apparatus may be used in the manufacture of ICs, integrated optical systems, guidance and detection patterns for magnetic domain memories, flat-panel displays, liquid crystal displays (LCDs), thin-film magnetic heads, etc. It should be appreciated that, in the context of such alternative applications, any use of the term “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The descriptions above are intended to be illustrative, not limiting. Thus, it should be appreciated that modifications may be made to the present invention as described without departing from the scope of the claims set out below.

It will be appreciated that embodiments of the invention may be used for any type of EUV source, including but not limited to a discharge produced plasma source (DPP source), or a laser produced plasma source (LPP source). However, an embodiment of the invention may be particularly suited to suppress radiation from a laser source, which typically forms part of a laser produced plasma source. This is because such a plasma source often outputs secondary radiation arising from the laser.

The spectral purity filter maybe located practically anywhere in the radiation path. In an embodiment, the spectral purity filter is located in a region that receives EUV containing radiation from the EUV radiation source and delivers the EUV radiation to a suitable downstream EUV radiation optical system, wherein the radiation from the EUV radiation source is arranged to pass through the spectral purity filter prior to entering the optical system. In an embodiment, the spectral purity filter is in the EUV radiation source. In an embodiment, the spectral purity filter is in the EUV lithographic apparatus, such as in the illumination system or in the projection system. In an embodiment, the spectral purity filter is located in a radiation path after the plasma but before the collector.

While specific embodiments of the present invention have been described above, it should be appreciated that the present invention may be practised otherwise than as described.

1. A spectral purity filter having a plurality of apertures, the filter comprising:
a substrate, including a first surface; and
a plurality of walls, the walls having side surfaces defining the plurality of apertures through the substrate,
wherein the side surfaces are inclined to a normal to the first surface.

2. A spectral purity filter according to claim 1, wherein the side surfaces are inclined to the normal to the first surface at an angle in the range of from about 1° to about 5°.

3. A spectral purity filter according to claim 1, wherein the side surfaces are inclined so that the apertures increase in width away from the first surface.

4. A spectral purity filter according to claim 1, wherein the side surfaces are inclined so that the apertures decrease in width away from the first surface.

5. A spectral purity filter according to claim 1, wherein the walls have a triangular cross-section in a plane perpendicular to the first surface.

6. A spectral purity filter according to claim 5, wherein the cross-section of the walls is an isosceles triangle.

7. A spectral purity filter according to claim h wherein each of the side surfaces has a first part proximate the first surface that is inclined so that the apertures decrease in width away from the first surface and a second part distal of the first surface that is inclined so that the apertures increase in width away from the first surface.

8. A spectral purity filter according to claim 7, wherein the walls have a cross-section in a plane perpendicular to the first surface that is a rhombus or kite-shape.

9. A spectral purity filter according to claim 1, wherein the side surfaces of at least one of the walls are inclined to the normal to the first surface at a different angle than the side surfaces of another one of the walls.

10. A spectral purity filter according to claim 9, wherein the side surfaces are inclined to the normal to the first surface at an angle that increases with increasing distance of the side surface from the center of the spectral purity filter.

11. A spectral purity filter according to claim 1, wherein the apertures have a hexagonal cross section in the plane of the first surface.

12. A spectral purity filter according to claim 1, further comprising a first layer, on the substrate to reflect radiation of a first wavelength.

13. A lithographic apparatus comprising:
a spectral purity filter having a plurality of apertures, the filter comprising
a substrate, including a first surface, and
a plurality of walls, the walls having side surfaces defining the plurality of apertures through the substrate,
wherein the side surfaces are inclined to a normal to the first surface.

14. A lithographic apparatus according to claim 13, further comprising:
an illumination system configured to condition a radiation beam;
a support configured to support a patterning device, the patterning device configured to impart the radiation beam with a patterned radiation beam;
a substrate table configured to hold a substrate; and
a projection system configured to project the patterned radiation beam onto a target portion of the substrate.

15. A device manufacturing method, comprising:
providing a radiation beam;
patterning the radiation beam;
projecting the patterned beam of radiation onto a target portion of a substrate; and enhancing the spectral purity of the radiation beam using a spectral purity filter having a plurality of apertures, the filter comprising a substrate, including a first surface, and a plurality of walls, the walls having side surfaces defining the plurality of apertures through the substrate, wherein the side surfaces are inclined to a normal to the first surface.
